(19) United States
(12) Patent Application Publication
(10) Pub. No.: US 2025/0016486 A1
(43) Pub. Date: Jan. 9, 2025

(54) AUDIO DEVICE

(71) Applicant: CLEPSEADRA, INC., Tokyo (JP)

(72) Inventors: Homare KON, Tokyo (JP); Yu MAENO, Tokyo (JP)

(73) Assignee: CLEPSEADRA, INC., Tokyo (JP)

(21) Appl. No.: 18/706,125

(22) PCT Filed: Nov. 21, 2022
(86) PCT No.: PCT/JP2022/043052

§ 371 Date: Apr. 30, 2024

(30) Foreign Application Priority Data
Nov. 26, 2021 (JP) 2021-191726
Jun. 14, 2022 (JP) 2022-095610

(51) Int. Cl. H04R 1/10

(52) U.S. Cl. CPC H04R 1/1016; H04R 1/1075; H04R 1/1083; H04R 2201/107

(57) ABSTRACT

An audio device that is wearable on a user, the audio device including comprising a mic, wherein the mic is disposed at a position at which at least part of a vibration section of the mic is included inside an external auditory canal of the user and at an angle at which the vibration section has a vibration direction toward an inner wall of the external auditory canal when the audio device is worn by the user.

### TECHNICAL FIELD

The present disclosure relates to an audio device.

### BACKGROUND ART

In recent years, binaural recording has attracted attention. The binaural recording is a technique of recording sounds transmitted to the eardrums of both ears of a human. Microphones (that will also be referred to simply as mics below) disposed close to the eardrums are used for binaural recording. The reproduction of sounds subjected to binaural recording with earphones, headphones, or the like makes it possible to replay so realistic sounds that a listener feels as if the listener was on the spot.

For example, Patent Literature 1 below proposes a binaural recording device including mics for noise cancellation provided outside earphones held on ears by inserting earpieces to external auditory canals.

### CITATION LIST

### Patent Literature

Patent Literature 1: JP 2009-49947A

### SUMMARY OF INVENTION

### Technical Problem

The device disclosed in Patent Literature 1 or the like has various disadvantages. For example, much wind noise is sometimes recorded.

Accordingly, the present disclosure has been devised in view of the problems. An object of the present disclosure is to provide a mechanism that allows the quality of binaural recording to increase.

### Solution to Problem

To solve the above described problem, according to an aspect of the present disclosure, there is provided an audio device that is wearable on a user, the audio device comprising a mic, wherein the mic is disposed at a position at which at least part of a vibration section of the mic is included inside an external auditory canal of the user and at an angle at which the vibration section has a vibration direction toward an inner wall of the external auditory canal when the audio device is worn by the user.

The mic may be disposed at an angle at which the vibration direction of the vibration section is orthogonal or substantially orthogonal to the inner wall of the external auditory canal when the audio device is worn by the user.

The audio device may comprise an insertion unit at least part of which is inserted to the external auditory canal when the audio device is worn by the user, wherein the mic may be disposed in the insertion unit.

The insertion unit may be configured as a tubular body including a through hole that extends through the tubular body in an insertion direction, and the mic may be disposed inside the through hole with a gap provided between the mic and an inner surface of the insertion unit.

An outer surface of the insertion unit may include a contact region that comes into contact with the inner wall of the external auditory canal and a noncontact region that is separated from the inner wall of the external auditory canal when the insertion unit is inserted to the external auditory canal.

The mic may be disposed at a position on a side of the insertion unit farther from an eardrum of the user when the audio device is worn by the user.

The audio device may comprise a first frame that is disposed in a cavum concha of the user when the audio device is worn by the user, wherein the first frame may be connected to the insertion unit.

The first frame may be configured in a shape of a ring, and an outside surface of the first frame may abut the cavum concha when the audio device is worn by the user.

The first frame may be configured to be uneven in thickness.

The audio device may comprise a fourth frame configured to close at least part of a hollow portion of the shape of the ring of the first frame.

The first frame may be configured in a shape of an arc, and an outside surface of the first frame may abut the cavum concha when the audio device is worn by the user.

The audio device may comprise a filter configured to attenuate wind, wherein the filter may be disposed on at least any of the first frame or the insertion unit.

A speaker may be disposed in contact with the first frame.

The audio device may comprise a second frame configured to abut a cymba concha of the user when the audio device is worn by the user, wherein the second frame may be connected to the first frame.

The audio device may comprise a third frame that is curved to pass through outside of a helical crus of the user from a front surface of an auricle of the user to a back surface of the auricle when the audio device is worn by the user, wherein the third frame may be connected to the first frame.

A portion of the first frame that is connected to the insertion unit, the second frame, or the third frame may be configured to have greater thickness than thickness of another portion.

To solve the above described problem, according to another aspect of the present disclosure, there is provided an audio device that is wearable on a user, the audio device comprising: a mic; a speaker; a plurality of supporting members each configured to support the speaker; and a frame configured to abut an ear of the user when the audio device is worn by the user, wherein the mic is disposed at a position at which at least part of a vibration section of the mic is included inside an external auditory canal of the user when the audio device is worn by the user, and a plurality of the supporting members separated from each other is connected to the frame.

The audio device may comprise a speaker, wherein the speaker may be disposed with a sound emission unit of the speaker opposed to an opening on an opposite side of the through hole to the insertion direction, the through hole being provided in the insertion unit.

The audio device may comprise a speaker, wherein the speaker may be disposed at a position and in an attitude at which and in which the speaker does not interfere with a tragus of the user when the audio device is worn by the user.

The audio device may comprise: a speaker; a frame configured to abut an ear of the user when the audio device is worn by the user; a storage unit configured to store the speaker; and a supporting member that is connected to the frame, the supporting member being configured to support the storage unit, wherein the storage unit may include an opening and stores the speaker with a sound emission unit of the speaker exposed from the opening, and a speaker cable that connects the speaker and another device may be connected to a bottom surface of the speaker through a through hole and a gap between the speaker and the storage unit, the through hole being provided in the frame, the gap causing the opening and a space on the bottom surface side of the speaker to communicate with each other.

### Advantageous Effects of Invention

As described above, according to the present disclosure, there is provided a mechanism that allows the quality of binaural recording to increase.

### BRIEF DESCRIPTION OF DRAWINGS

FIG. 1 is a front view of a left ear of a user in which an audio device according to a first embodiment of the present disclosure is worn on the left ear.

FIG. 2 is a perspective view of the audio device according to the embodiment.

FIG. 3 is a front view of the audio device according to the embodiment.

FIG. 4 is a bottom view of the audio device according to the embodiment.

FIG. 5 is a perspective view of a cross section of the audio device taken along arrows 9-9 illustrated in FIG. 3.

FIG. 6 is a diagram schematically illustrating disposition of a sound collection unit included in the audio device according to the embodiment.

FIG. 7 is a diagram for describing thickness of a first frame according to the embodiment.

FIG. 8 is a front view of an audio device according to a first modification example.

FIG. 9 is a perspective view of an audio device according to a second modification example.

FIG. 10 is a perspective view of an audio device according to a third modification example.

FIG. 11 is a diagram schematically illustrating a configuration of an audio device according to a fourth modification example.

FIG. 12 is a diagram schematically illustrating the configuration of the audio device according to the fourth modification example.

FIG. 13 is a diagram for describing a disposition example of a speaker.

FIG. 14 is a diagram for describing a disposition example of the speaker.

FIG. 15 is a diagram for describing a disposition example of the speaker.

FIG. 16 is a diagram for describing a disposition example of the speaker.

FIG. 17 is a front view of a left ear of a user in which an audio device according to a second embodiment is worn on the left ear.

FIG. 18 is a perspective view of the audio device according to the embodiment.

FIG. 19 is a front view of a frame portion of the audio device according to the embodiment.

FIG. 20 is a back view of a frame portion of the audio device according to the embodiment.

FIG. 21 is a right side view of the frame portion of the audio device according to the embodiment.

FIG. 22 is a left side view of the frame portion of the audio device according to the embodiment.

FIG. 23 is a plan view of the frame portion of the audio device according to the embodiment.

FIG. 24 is a bottom view of the frame portion of the audio device according to the embodiment.

FIG. 25 is a perspective view in which a speaker cable and a mic cable are connected to the audio device according to the embodiment.

FIG. 26 is a cross-sectional view of a cross section of the audio device taken along arrows 7-7 illustrated in FIG. 18.

FIG. 27 is a cross-sectional view of a cross section of the audio device taken along arrows 8-8 illustrated in FIG. 18.

### DESCRIPTION OF EMBODIMENTS

Hereinafter, referring to the appended drawings, preferred embodiments of the present disclosure will be described in detail. It should be noted that, in this specification and the appended drawings, structural elements that have substantially the same function and structure are denoted with the same reference numerals, and repeated explanation thereof is omitted.

### <1. Technical Problems>

The reproduction of content subjected to binaural recording is also referred to as binaural reproduction. To increase a realistic sensation produced by the content, it is desirable to perform preliminary measurement and binaural reproduction by using mics and speakers whose positions are fixed relative to eardrums. In the preliminary measurement, sounds outputted from the speakers are recorded by the mics to measure device characteristics and auricular characteristics of a user. In the binaural reproduction, a digital filter based on the inverse characteristics of the preliminarily measured device characteristics and the inverse characteristics of the preliminarily measured auricular characteristics are applied to the content subjected to binaural recording and the content is then reproduced.

Patent Literature 1 above discloses an external auditory canal insertion device that is held on ears by inserting earpieces to external auditory canals and includes speakers and mics. When the device is held on the ears, the mics are exposed to the outside world and held in the direction of the outside world. Such a conventionally developed device for binaural recording has various disadvantages.

First, much wind noise is sometimes recorded. The wind noise is undesirable sound detected due to the influence of wind. In particular, wind noise detected due to the influence of voice is also referred to as pop noise. Much wind noise causes the quality of binaural recording to significantly decrease.

Second, when the external auditory canal insertion device closes the external auditory canals, it is difficult for the user to clearly hear ambient sounds.

Accordingly, the present disclosure provides an audio device that makes it possible to solve the technical problems described above.

### 2. First Embodiment

### <2.1. Configuration Example>

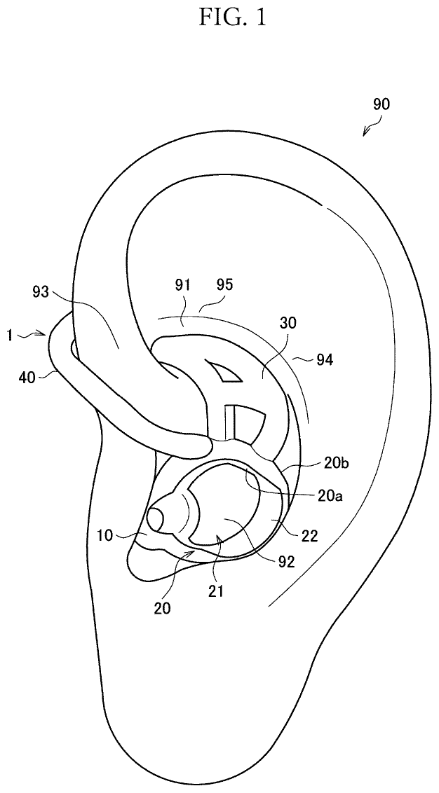

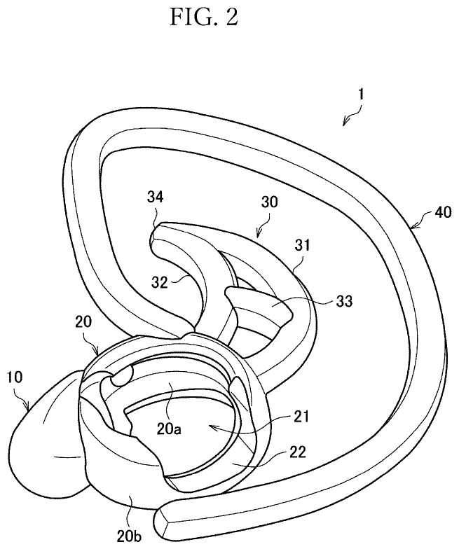

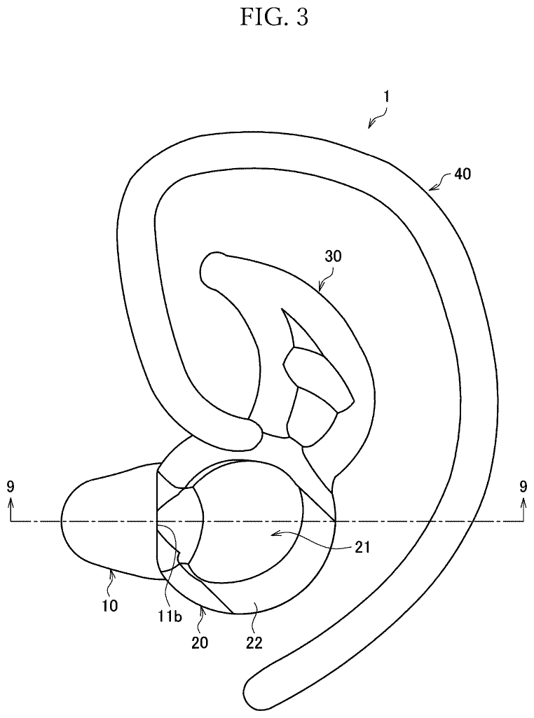

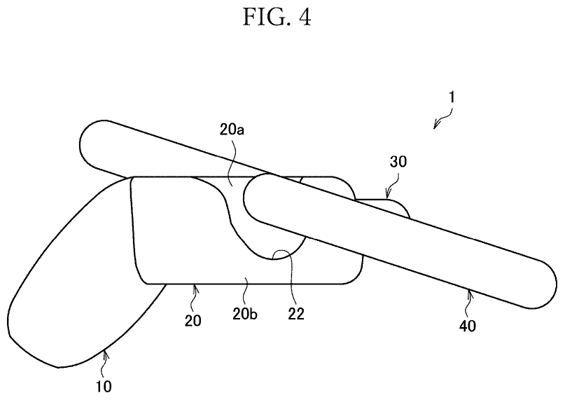

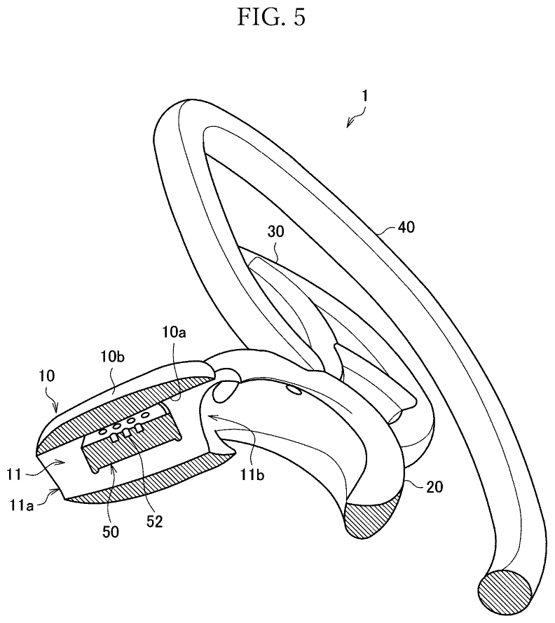

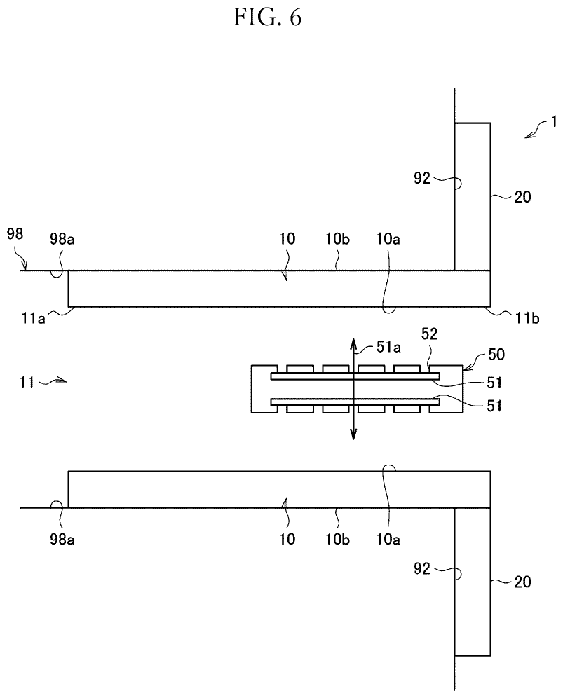

The following describes an example of a configuration of an audio device 1 according to a first embodiment of the present disclosure with reference to FIGS. 1 to 6. FIG. 1 is a front view of a left ear of a user in which the audio device 1 according to the present embodiment is worn on the left ear. FIG. 2 is a perspective view of the audio device 1 according to the present embodiment. FIG. 3 is a front view of the audio device 1 according to the present embodiment. FIG. 4 is a bottom view of the audio device 1 according to the present embodiment. FIG. 5 is a perspective view of a cross section of the audio device 1 taken along arrows 9-9 illustrated in FIG. 3. FIG. 6 is a diagram schematically illustrating the disposition of a sound collection unit 50 included in the audio device 1 according to the present embodiment.

As illustrated in FIG. 1, the audio device 1 is wearable on a user. It should be noted that FIGS. 1 to 6 each illustrate a configuration of the audio device 1 which is worn on the left ear of a user. The audio device 1 for a right ear has a configuration bilaterally symmetrical to this configuration. As illustrated in FIGS. 1 to 6, the audio device 1 includes an insertion unit 10, a first frame 20, a second frame 30, a third frame 40, and the sound collection unit 50.

As illustrated in FIG. 6, at least part of the insertion unit 10 is inserted to an external auditory canal 98 when the audio device 1 is worn by a user. The insertion unit 10 is inserted toward the eardrum from the entrance of the external auditory canal 98 along the direction (that will also be referred to as an insertion direction below) in which the external auditory canal 98 extends. The side of the insertion unit 10 that is inserted toward the eardrum will also be referred to as a point and the opposite side will also be referred to as a distal end.

The insertion unit 10 may include an elastic body such as a silicon resin. The insertion unit 10 inserted to the external auditory canal 98 is held in the external auditory canal 98 by restoring force generated when the insertion unit 10 is transformed along the shape of the external auditory canal 98. The outer diameter of at least part of the insertion unit 10 may be the same as the inner diameter of the external auditory canal 98, or greater than or equal to the inner diameter of the external auditory canal 98. In this case, the insertion unit 10 is pressed from the outer circumference by the external auditory canal 98 and held more firmly in the external auditory canal 98. It should be noted that the outer diameter of the insertion unit 10 is the length of the insertion unit 10 in the direction orthogonal to the insertion direction.

The sound collection unit 50 is a unit that acquires ambient sound. If described in detail, the sound collection unit 50 converts sound produced in the surrounding space to an analog signal and outputs the converted analog signal. The sound collection unit 50 may be a so-called microphone (that will also be referred simply as a mic below). The sound collection unit 50 may be, for example, a capacitor mic or a MEMS (Micro Electro Mechanical Systems) mic. It should be noted that a so-called electret capacitor mic including an electret element for a diaphragm, a back electrode, or a back chamber may be used as the capacitor mic in addition to a type of mic in which a diaphragm receives a direct-current voltage from the outside. In addition, the sound collection unit 50 may be a dynamic mic such as a moving-coil mic. The following gives description on the assumption that the sound collection unit 50 is a mic. An ADC (Analog Digital Converter), an amplifier, a recording device, and the like may be connected to the sound collection unit 50.

As illustrated in FIGS. 5 and 6, the sound collection unit 50 includes a vibration section 51 and a tone hole 52. The vibration section 51 is a member that vibrates in response to coming sound. The vibration section 51 may be a vibration plate or a vibration membrane. The tone hole 52 is a hole made on a housing of the sound collection unit 50. The tone hole 52 connects the space in the sound collection unit 50 in which the vibration section 51 is provided and the outside world. Sound coming to the sound collection unit 50 passes through the tone hole 52 and reaches the vibration section 51, and vibrates the vibration section 51. The vibration of the vibration section 51 is converted to an electrical signal serving as sound.

As illustrated in FIGS. 5 and 6, the sound collection unit 50 is disposed in the insertion unit 10. According to this configuration, when the audio device 1 is worn by a user, the sound collection unit 50 is disposed at a position close to an eardrum of the user. This allows the quality of binaural recording to increase.

As illustrated in FIGS. 5 and 6, the insertion unit 10 is a tubular body including a through hole 11 that extends through the tubular body in the insertion direction. The sound collection unit 50 is then disposed inside the through hole 11 with a gap provided between the sound collection unit 50 and an inner surface 10a (i.e., the wall surface of the through hole 11) of the insertion unit 10. According to this configuration, sound coming from the outside world passes through the through hole 11 from a distal end side opening 11b to a point side opening 11a and reaches an eardrum of a user. This allows the user to clearly hear ambient sound when wearing the audio device 1. In addition, it is possible for the sound collection unit 50 to record the sound coming from the outside world and passing through the through hole 11.

It should be noted that an outer surface 10b of the insertion unit 10 and an inner wall 98a of the external auditory canal 98 are in contact in FIG. 6, but there may be a gap between them. That is, the outer surface 10b of the insertion unit 10 may include a noncontact region that is separated from the inner wall 98a of the external auditory canal 98 in addition to a contact region that comes into contact with the inner wall 98a of the external auditory canal 98. This noncontact region is included, for example, as a groove extending in the insertion direction. A gap that causes the space on the point side of the insertion unit 10 and the space on the distal end side to communicate with each other is formed between the noncontact region and the inner wall 98a of the external auditory canal 98. Sound passing through this gap may then come into the through hole 11 from the point side opening 11a and be recorded by the sound collection unit 50. In addition, it is possible for a user to catch the sound passing through this gap.

In addition, the insertion unit 10 may be configured in size that prevents the insertion unit 10 from sealing the entrance of the external auditory canal 98. The sealing here refers to the entire outer surface 10b of the insertion unit 10 coming into contact with the inner wall 98a of the external auditory canal 98. According to this configuration, the gap that causes the space on the point side of the insertion unit 10 and the space on the distal end side to communicate with each other may be formed between the outer surface 10b of the insertion unit 10 and the inner wall 98a of the external auditory canal 98. In that case, it is possible for a user to catch the sound passing through this gap.

Here, as illustrated in FIG. 6, the sound collection unit 50 is disposed at a position at which at least part of the vibration section 51 is included inside the external auditory canal 98 of a user and at an angle at which the vibration section 51 has a vibration direction 51a toward the inner wall 98a of the external auditory canal 98 when the audio device 1 is worn by the user. According to this configuration, the vibration section 51 is disposed at a position close to an eardrum of the user. This allows the quality of binaural recording to increase. In addition, the coming direction of wind from the outside world is considered to be the same or substantially the same as the insertion direction. In this respect, the disposition of the vibration section 51 at this angle allows the vibration direction 51a of the vibration section 51 and the coming direction of wind to be different. It is thus possible to reduce the vibration of the vibration section 51 caused by coming wind, allowing wind noise to be reduced.

It should be noted that including at least part of the vibration section 51 inside the external auditory canal 98 may mean that at least some of the tone holes 52 are included inside the external auditory canal 98. Similarly, the vibration section 51 having a vibration direction toward the inner wall 98a of the external auditory canal 98 may mean that the tone holes 52 each face the inner wall 98a of the external auditory canal 98. In addition, speaking of the relationship with the insertion unit 10, the sound collection unit 50 is disposed at an angle at which the vibration section 51 has the vibration direction 51a toward the inner surface 10a of the insertion unit 10 or the tone hole 52 faces the inner surface 10a of the insertion unit 10.

Furthermore, it is desirable that the sound collection unit 50 be disposed at an angle at which the vibration direction 51a of the vibration section 51 is orthogonal or substantially orthogonal to the inner wall 98a of the external auditory canal 98 as illustrated in FIG. 6 when the audio device 1 is worn by a user. More simply, it is desirable that the sound collection unit 50 be disposed at an angle at which the vibration section 51 is parallel or substantially parallel with the external auditory canal 98. According to this configuration, it is possible to make the vibration direction 51a of the vibration section 51 and the coming direction of wind orthogonal or substantially orthogonal to each other. That is, it is possible to make the least the vibration of the vibration section 51 caused by coming wind, allowing wind noise to be further reduced.

It should be noted that the vibration direction 51a of the vibration section 51 being orthogonal or substantially orthogonal to the inner wall 98a of the external auditory canal 98 may mean that the direction in which the tone hole 52 faces is orthogonal or substantially orthogonal to the inner wall 98a of the external auditory canal 98. In addition, speaking of the relationship with the insertion unit 10, the sound collection unit 50 is disposed at an angle at which the vibration direction 51a of the vibration section 51 or the direction in which the tone hole 52 faces is orthogonal or substantially orthogonal to the inner surface 10a of the insertion unit 10.

As illustrated in FIG. 6, the sound collection unit 50 may be disposed at a position on the side of the insertion unit 10 farther from an eardrum of a user when the audio device 1 is worn by the user. For example, the sound collection unit 50 may be disposed on the side of the through hole 11 of the insertion unit 10 closer to the distal end side opening 11b. According to this configuration, it is possible to record sound coming from the outside world with higher sound quality.

As illustrated in FIGS. 1 to 6, the first frame 20 is connected to the insertion unit 10. The first frame 20 is then disposed in a cavum concha 92 as illustrated in FIG. 1 when the audio device 1 is worn by a user. According to this configuration, it is possible to limit the movement of the insertion unit 10 by using the positional relationship between the first frame 20 and the cavum concha 92. For example, it is possible to prevent the insertion unit 10 from having a positional shift such as being excessively inserted to the external auditory canal 98, coming out from the external auditory canal 98, or rotating in the external auditory canal 98.

As illustrated in FIG. 1, the outside surface 20b of the first frame 20 abuts the cavum concha 92 when the audio device 1 is worn by a user. The first frame 20 may include an elastic body such as a silicon resin. The first frame 20 abutting the cavum concha 92 may be held by the cavum concha 92 with restoring force generated when the first frame 20 is transformed along the shape of the cavum concha 92. In this case, it is possible to prevent the audio device 1 from having a positional shift.

As illustrated in FIGS. 1 to 3, the first frame 20 is configured in the shape of a ring. The cavum concha 92 is thus exposed to the outside world through a hollow portion 21 surrounded by an inside surface 20a of the first frame 20 configured in the shape of a ring as illustrated in FIG. 1 when the audio device 1 is worn by a user. Reflection characteristics of the cavum concha 92 of the user are thus reflected in sound to be subjected to binaural recording. This allows the quality of the binaural recording to increase. In addition, the configuration of the first frame 20 in the shape of a ring sufficiently permits the first frame 20 to be transformed along the shape of the cavum concha 92. In other words, it is possible to keep the shape of the cavum concha 92 before and after the audio device 1 is worn by a user. It is thus possible to prevent the reflection characteristics of the cavum concha 92 of the user from changing before and after the audio device 1 is worn and increase the quality of binaural recording.

As illustrated in FIGS. 1 to 5, the insertion unit 10, the second frame 30, and the third frame 40 are each connected to the first frame 20. The insertion unit 10, the first frame 20, the second frame 30, and the third frame 40 may each include the same material. In that case, the insertion unit 10, the first frame 20, the second frame 30, and the third frame 40 may be integrally molded.

As illustrated in FIG. 2, the second frame 30 may be configured in a crescent shape. The second frame 30 includes a first columnar body 31 that is curved in the shape of an arc or substantially in the shape of an arc and forms the outer arc of the crescent shape, a second columnar body 32 that is curved in the shape of an arc or substantially in the shape of an arc and forms the inner arc of the crescent shape, and a third columnar body 33 that connects the first columnar body 31 and the second columnar body 32. Ends of the first columnar body 31 and the second columnar body 32 are connected to configure a point 34. Meanwhile, the other ends of the first columnar body 31 and the second columnar body 32 are each connected to the first frame 20.

The second frame 30 abuts a cymba concha 91 of a user as illustrated in FIG. 1 when the audio device 1 is worn by the user. If described in detail, the first columnar body 31 abuts the side of the cymba concha 91 closer to an antihelix 94 or an antihelical crus 95. Meanwhile, the second columnar body 32 abuts the side of the cymba concha 91 closer to a helical crus 93. The second frame 30 is then locked in the cymba concha 91 with the point 34 of the second frame 30 hung on the helical crus 93 from the cymba concha 91 side. According to this configuration, it is possible to prevent the audio device 1 from having a positional shift due to a user operation.

As illustrated in FIGS. 1 and 2, the third frame 40 is curved to pass through the outside of the helical crus 93 of a user from the front surface of an auricle 90 of the user to the back surface of the auricle 90 when the audio device 1 is worn by the user. An end of the third frame 40 is connected to the first frame 20. The other end of the third frame 40 is positioned on the back surface of the auricle 90 when the audio device 1 is worn by a user. The audio device 1 is worn by a user with the third frame 40 hung on the auricle 90. According to this configuration, it is possible to prevent the audio device 1 from falling down.

The first frame 20 is configured to be uneven in thickness. For example, as illustrated in FIGS. 1 to 4, the first frame 20 may be provided with a notch 22. The thickness of the portion provided with the notch 22 is less than the thicknesses of the other portions. As illustrated in FIG. 1, the notch 22 may be provided at a position at which the notch 22 abuts a relatively shallow lower portion of the cavum concha 92 when the audio device 1 is worn by a user. In that case, it is possible to increase the wearability of the audio device 1 while keeping the strength of the first frame 20 at the thick portion of the first frame 20. In addition, a portion that abuts the relatively shallow portion of the cavum concha 92 like the notch 22 is configured to be thin. This makes it possible to reduce changes in the reflection characteristics of the cavum concha 92 caused by the worn audio device 1 and increase the quality of binaural recording.

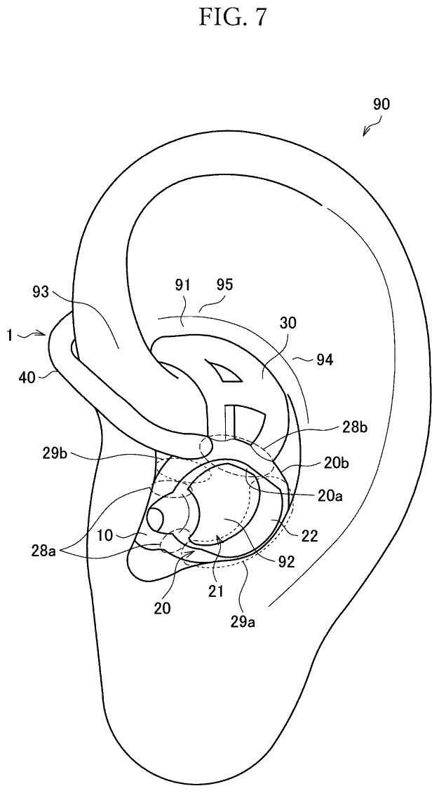

In particular, it is desirable that a portion of the first frame 20 which is connected to the insertion unit 10, the second frame 30, or the third frame 40 be configured to have greater thickness than the thicknesses of the other portions. For example, the portion of the first frame 20 to which the insertion unit 10, the second frame 30, or the third frame 40 is connected is desirably configured to be thick and the notch 22 is desirably provided at a position apart from them. According to this configuration, it is possible to increase the wearability of the audio device 1 while securing strength for connecting the insertion unit 10, the second frame 30, and the third frame 40 to the first frame 20. The thickness of the first frame 20 will be described in detail with reference to FIG. 7.

FIG. 7 is a diagram for describing the thickness of the first frame 20 according to the present embodiment. As illustrated in FIG. 7, a portion 28a of the first frame 20 to which the insertion unit 10 is connected and a portion 28b to which the second frame 30 and the third frame 40 are connected are desirably configured to be thick. Meanwhile, at least part of each of portions 29a and 29b of the first frame 20 between the portion 28a to which the insertion unit 10 is connected and the portion 28b to which the second frame 30 and the third frame 40 are connected may be configured to be thin. Speaking of the positional relationship with the auricle 90, when the audio device 1 is worn by a user, at least part of the portion 29a of the first frame 20 from the region below the cavum concha 92 to the region close to the border between the cavum concha 92 and the cymba concha 91 or the portion 29b near the helical crus 93 may be configured to be thin.

### <2.2. Modification Examples>

### (1) First Modification Example

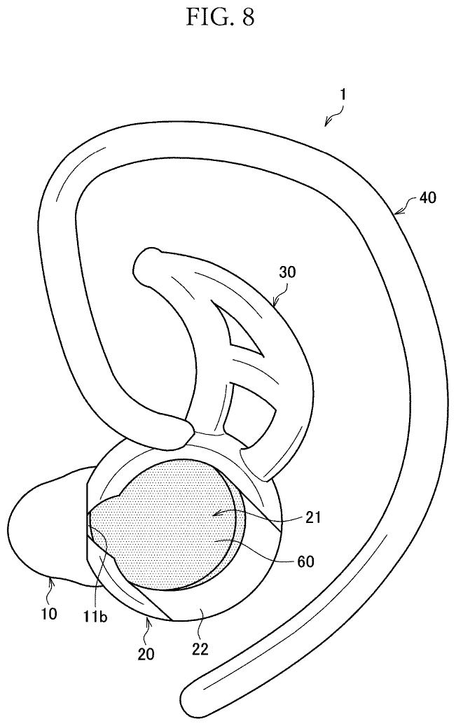

FIG. 8 is a front view of the audio device 1 according to a first modification example. As illustrated in FIG. 8, the audio device 1 according to the present modification example includes a filter 60 that attenuates wind. The filter 60 is a member that blocks the passage of wind while having air permeability. The filter 60 is configured in the shape of a sponge by using, for example, a resin material such as urethane. Additionally, the filter 60 may be configured by using, for example, a fur material.

The filter 60 is disposed on at least any of the insertion unit 10 or the first frame 20. In the example illustrated in FIG. 8, the filter 60 is disposed on the insertion unit 10 and the first frame 20. If described in detail, the filter 60 is disposed to close at least part of the distal end side opening 11b of the through hole 11 of the insertion unit 10. According to this configuration, it is possible to attenuate wind that comes to the external auditory canal 98 from the outside world and reaches the sound collection unit 50. In addition, the filter 60 is disposed to close at least part of the hollow portion 21 of the first frame 20. According to this configuration, it is possible to attenuate wind that comes from the outside world and is reflected by the cavum concha 92, and consequently attenuate wind that reaches the sound collection unit 50. In this way, it is possible to further reduce wind noise.

### (2) Second Modification Example

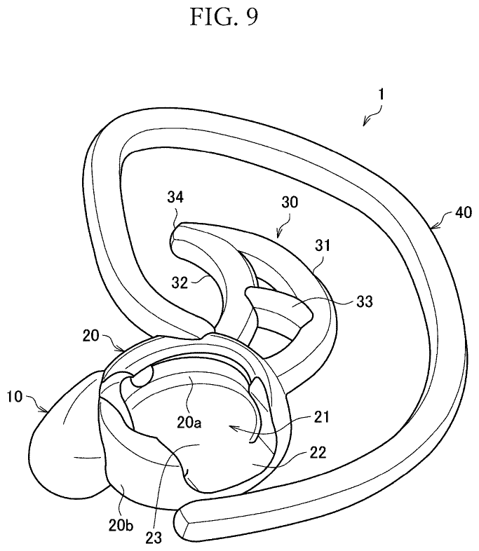

FIG. 9 is a perspective view of the audio device 1 according to a second modification example. As illustrated in FIG. 9, the audio device 1 according to the present modification example includes a fourth frame 23 that closes at least part of the hollow portion 21 of the shape of the ring of the first frame 20. In the example illustrated in FIG. 9, the fourth frame 23 is configured in the shape of a plate having the same height as the height of the notch 22. The fourth frame 23 is connected to the first frame 20 to close the opening on the side of the hollow portion 21 closer to the cavum concha 92. The first frame 20 and the fourth frame 23 may be integrally molded. According to this configuration, it is possible to further increase the strength of the first frame 20. In addition, when the filter 60 is disposed in the audio device 1, it is possible to hold the filter 60 more strongly with the fourth frame 23.

It should be noted that the fourth frame 23 may be configured in the shape of a mesh. In this case, the cavum concha 92 is exposed to the outside world through the gaps of the mesh. The reflection characteristics of the cavum concha 92 of the user are thus reflected in sound to be subjected to binaural recording. This allows the quality of the binaural recording to increase.

### (3) Third Modification Example

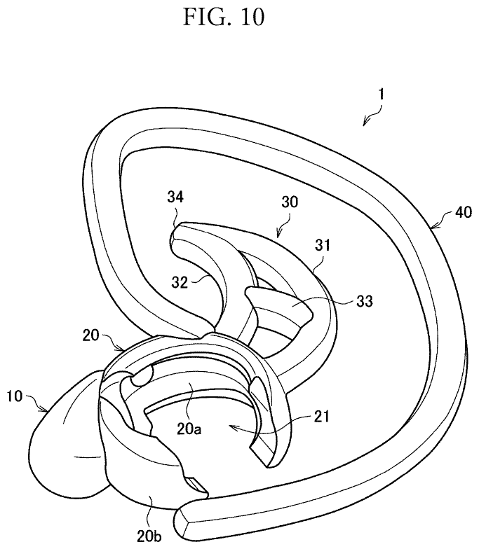

FIG. 10 is a perspective view of the audio device 1 according to a third modification example. As illustrated in FIG. 10, the first frame 20 according to the present modification example is configured in the shape of an arc. The first frame 20 illustrated in FIG. 10 has a shape in which the portion of the first frame 20 provided with the notch 22 described in the embodiment is cut away. As in the embodiment, the outside surface 20b of the first frame 20 abuts the cavum concha 92 when the audio device 1 according to the present modification example is worn by a user. According to this configuration, it is possible to prevent the audio device 1 from having a positional shift as in the embodiment. Further, it is possible to reduce the weight of the audio device 1 in the present modification example as compared with the embodiment. This makes it possible to further increase the wearability.

The position and area of the portion of the first frame 20 to be cut away are not limited to the example illustrated in FIG. 10. A portion at any position and in any area of the portion 29a or 29b configurable to be thin that has been described with reference to FIG. 7 may be cut away.

### (4) Fourth Modification Example

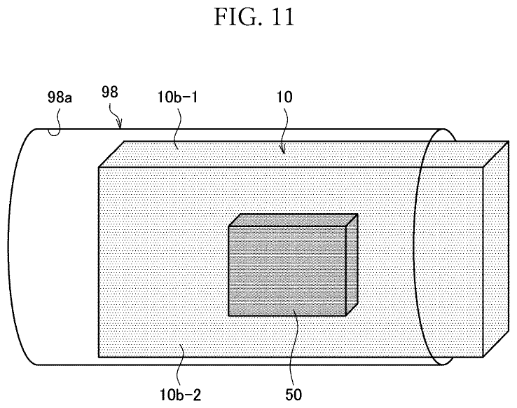

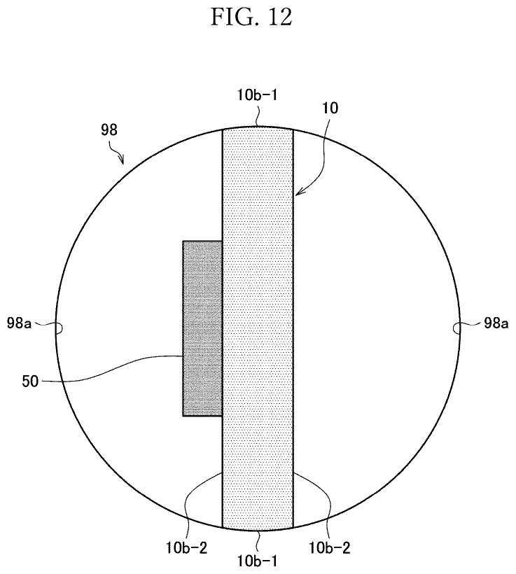

Each of FIGS. 11 and 12 is a diagram schematically illustrating a configuration of the audio device 1 according to a fourth modification example. FIG. 11 schematically illustrates a portion of the audio device 1 inserted to the external auditory canal 98. FIG. 12 schematically illustrates a portion of the audio device 1 inserted to the external auditory canal 98 as viewed from the outside of the external auditory canal 98.

As illustrated in FIGS. 11 and 12, the insertion unit 10 may be configured in the shape of a plate. The outer surface 10b of the insertion unit 10 configured in the shape of a plate then includes a contact region 10b-1 that comes into contact with the inner wall 98a of the external auditory canal 98 and a noncontact region 10b-2 that is separated from the inner wall 98a of the external auditory canal 98 when the insertion unit 10 is inserted to the external auditory canal 98. The contact region 10b-1 and the noncontact region 10b-2 are surfaces of the outer surface 10b of the insertion unit 10 configured in the shape of a plate that extend in the insertion direction. The distance between the opposed contact regions 10b-1 is the same as the inner diameter of the external auditory canal 98, or greater than or equal to the inner diameter of the external auditory canal 98. The insertion unit 10 is thus inserted to the external auditory canal 98 to push open the external auditory canal 98 with the two contact regions 10b-1 and held in the external auditory canal 98. Meanwhile, the distance between the opposed noncontact regions 10b-2 is less than the inner diameter of the external auditory canal 98. This provides a gap between each of the noncontact regions 10b-2 and the inner wall 98a of the external auditory canal 98 when the insertion unit 10 is inserted to the external auditory canal 98. According to this configuration, sound coming from the outside world passes through the gap and reaches an eardrum of a user. This allows the user to clearly hear ambient sound when wearing the audio device 1. As illustrated in FIGS. 11 and 12, the sound collection unit 50 is disposed in the noncontact region 10b-2. It is thus possible for the sound collection unit 50 to record the sound coming from the outside world and passing through the gap.

Needless to say, the shape of the insertion unit 10 is not limited to the shape of a plate. The insertion unit 10 has any shape as long as the shape provides the insertion unit 10 with the contact region 10b-1 and the noncontact region 10b-2 and provides a gap between the noncontact region 10b-2 and the inner wall 98a of the external auditory canal 98.

In addition, in the example illustrated in any of FIGS. 11 and 12, both the two opposed outer surfaces 10b-1 of the insertion unit 10 having the shape of a plate are in contact with the inner wall 98a of the external auditory canal 98, but sections of the insertion unit 10 in contact with the inner wall 98a of the external auditory canal 98 are not limited to this example. For example, depending on the structures of the other portions of the insertion unit 10, any one of the two opposed outer surfaces 10b-1 may be in contact with the inner wall 98a of the external auditory canal 98 and the other may be out of contact.

### <2.3. Disposition of Speaker>

### (1) First Disposition Example

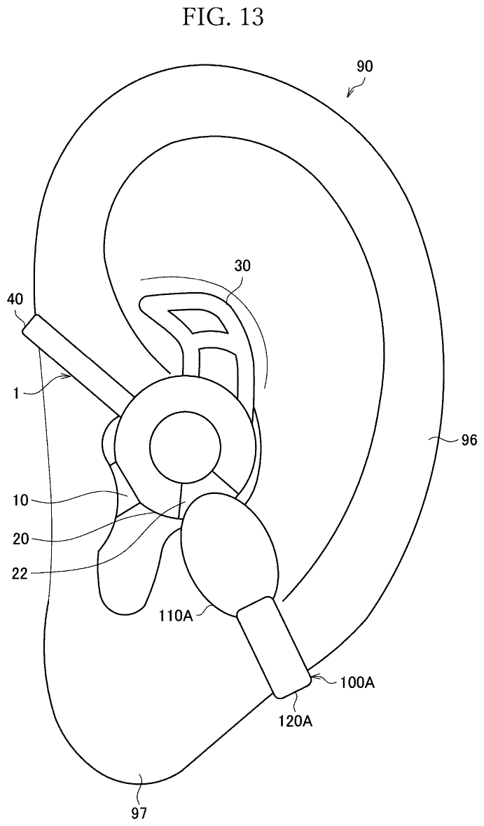

FIG. 13 is a diagram for describing a disposition example of a speaker. As illustrated in FIG. 13, a headphone 100A having the shape of an ear cuff may be worn by a user to cover part of the audio device 1 worn by the user. The headphone 100A includes a speaker 110A and a frame 120A.

The speaker 110A is a device that outputs sound. If described in detail, the speaker 110A converts an inputted analog signal to sound and emits the sound to the surrounding space. A DAC (Digital Analog Converter), an amplifier, a reproduction device, and the like may be connected to the speaker 110A. The speaker 110A may be used to acquire sound outputted from the speaker 110A by the sound collection unit 50 and measure the device characteristics and the auricular characteristics. In addition, the speaker 110A may be used for binaural reproduction.

The frame 120A is a member that holds the speaker 110A on the auricle 90. The frame 120A is curved to pass through the outside of at least any of a helix 96 or an earlobe 97 from the front surface of the auricle 90 to the back surface of the auricle 90 when the headphone 100A is worn by a user. The speaker 110A is connected to an end of the frame 120A. The frame 120A then clamps the auricle 90 from the front surface of the auricle 90 and the back surface of the auricle 90 with the speaker 110A connected to the end of the frame 120A and the other end of the frame 120A.

The speaker 110A is disposed in contact with the first frame 20. In particular, when the first frame 20 is provided with the notch 22, the speaker 110A may be positioned within the notch 22 as illustrated in FIG. 13. In this case, it is possible to guide the wearing position of the headphone 100A with the notch 22. In addition, it is possible to reduce interference between the audio device 1 and the headphone 100A by using the notch 22.

Needless to say, the speaker 110A may be disposed out of contact with the first frame 20. In that case, it is desirable to fix the position of the speaker 110A in contact with the auricle 90.

### (2) Second Disposition Example

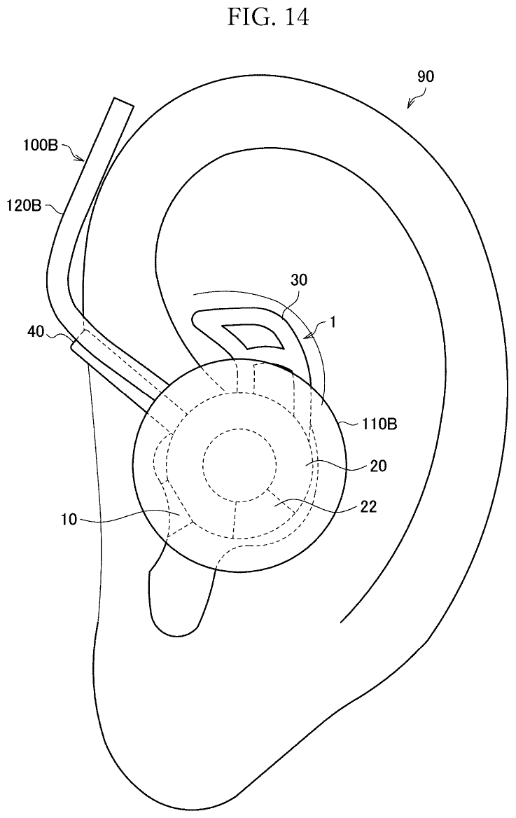

FIG. 14 is a diagram for describing a disposition example of a speaker. As illustrated in FIG. 14, a headphone 100B that is hung on an ear may be worn by a user to cover part of the audio device 1 worn by the user. The headphone 100B includes a speaker 110B and a frame 120B.

The speaker 110B has a configuration similar to the configuration described in the first disposition example.

The frame 120B is a member that holds the speaker 110B on the auricle 90. The frame 120B is curved to pass over the head of a user when the headphone 100B is worn by the user. The two speakers 110B to be disposed on both ears are then connected to both ends of the frame 120B. The frame 120B then clams the head of a user from the left and right sides with the two speakers 110B disposed on both ears.

The speaker 110B is disposed in contact with the first frame 20. In particular, the speaker 110B is disposed to come into contact with the top surface of the first frame 20. The top surface of the first frame 20 may be provided with a member for preventing a slip or vibration. The member may be configured in the shape of a sponge by using, for example, a resin material such as urethane. In this case, it is possible to prevent noise from being generated due to the friction between the first frame 20 and the speaker 110B.

Needless to say, the speaker 110B may be disposed out of contact with the first frame 20. In that case, it is desirable to fix the position of the speaker 110B in contact with the auricle 90.

It should be noted that an overhead headphone is possible as a headphone to be worn by a user to cover part of the audio device 1 worn by the user in addition to the headphone hung on an ear described above.

### (3) Third Disposition Example

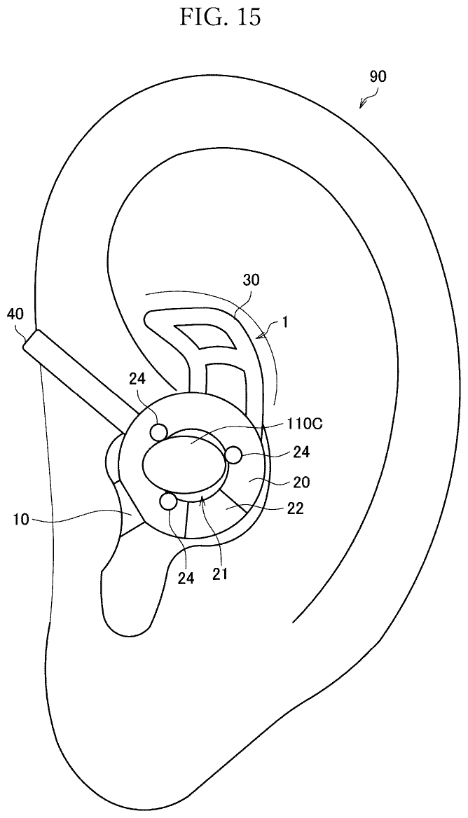

FIG. 15 is a diagram for describing a disposition example of a speaker. As illustrated in FIG. 15, a speaker 110C may be disposed on the audio device 1 worn by a user.

The speaker 110C has a configuration similar to the configuration described in the first disposition example.

The first frame 20 is provided with three supports 24. Each of the supports 24 is a member that is connected to the first frame 20 to allow the speaker 110C to be attached and detached. The support 24 may be a projection including, for example, an elastic body such as a silicon resin. When the speaker 110C is disposed in the space surrounded by the three supports 24, the three supports 24 are pushed open by the speaker 110C and clamps the speaker 110C with the restoring force. Needless to say, the number of supports 24, the shape of each support 24, and the holding method are not limited to the example described above.

### (4) Fourth Disposition Example

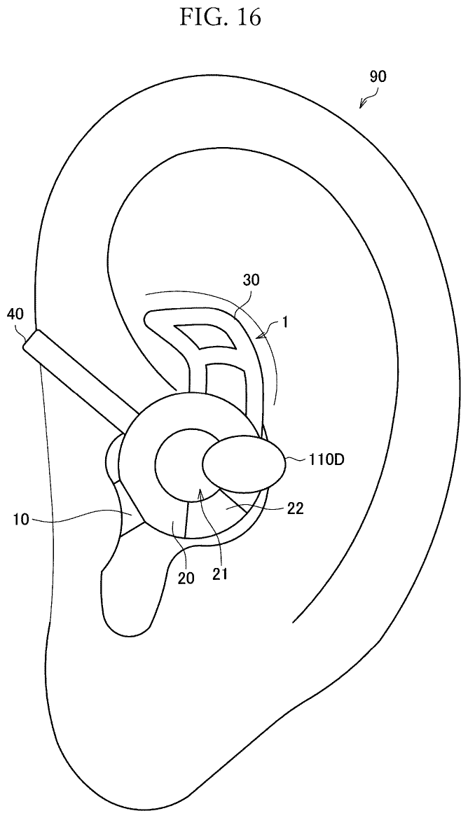

FIG. 16 is a diagram for describing a disposition example of a speaker. As illustrated in FIG. 16, a speaker 110D may be disposed on the audio device 1 worn by a user.

The speaker 110D has a configuration similar to the configuration described in the first disposition example.

The speaker 110D is disposed in contact with the first frame 20. In particular, the speaker 110D is fixed to the first frame 20.

### (5) Conclusion

In any of the first to fourth configuration examples described above, the speaker 110 (110A to 110D) is disposed in contact with the first frame 20. This makes it possible to fix or substantially fix the relative positional relationship between an eardrum of a user, the sound collection unit 50, and the speaker 110. It is thus possible to sufficiently increase a realistic sensation when content subjected to binaural recording by using the sound collection unit 50 is subjected to binaural reproduction from the speaker 110.

It should be noted that the speaker 110 desirably covers part of the hollow portion 21 and open other part toward the outside world when disposed on the first frame 20 in any of the third and fourth configuration examples. This is because it is possible to record ambient sound and it is additionally possible for the speaker 110 to function as the filter 60 to attenuate wind.

### 3. Second Embodiment

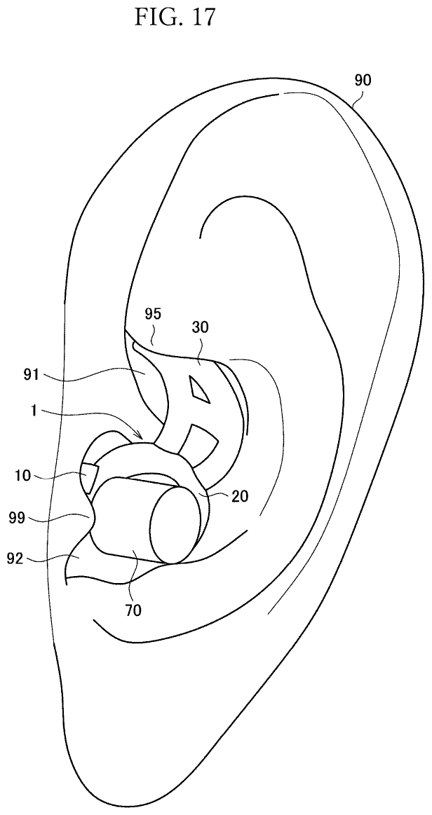

The following describes a configuration example of the audio device 1 according to a second embodiment with reference to FIGS. 17 to 24.

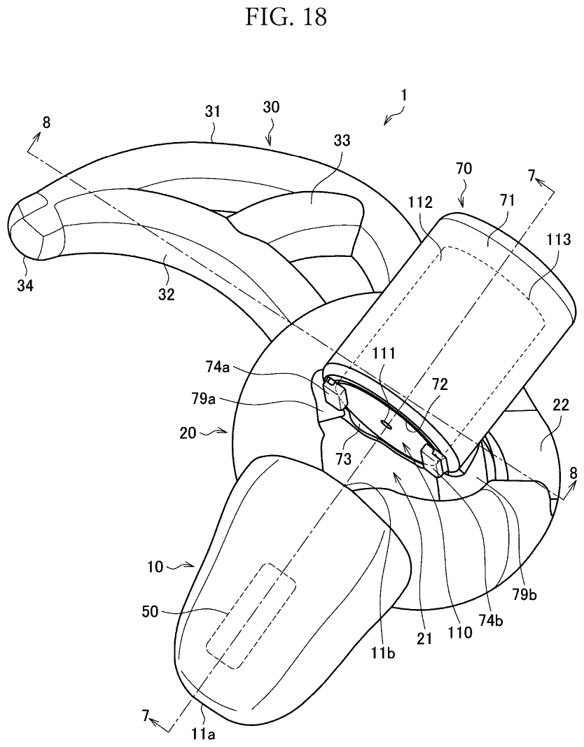

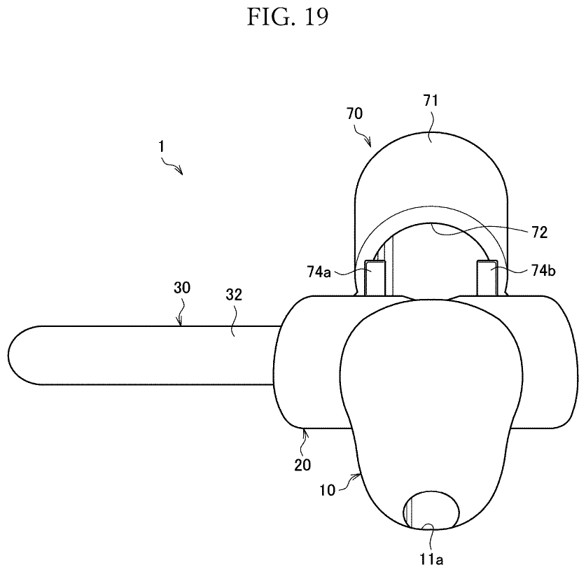

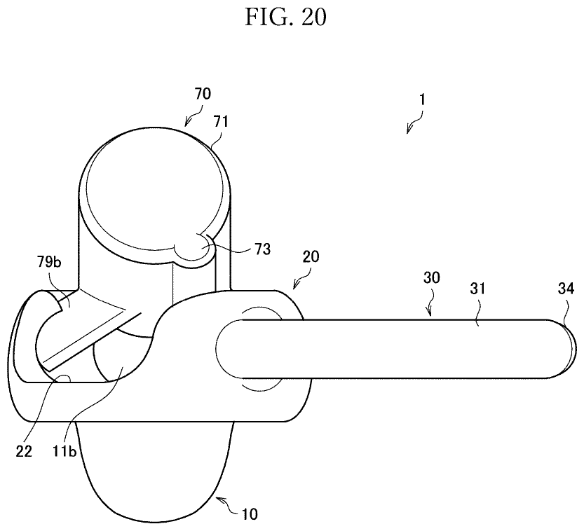

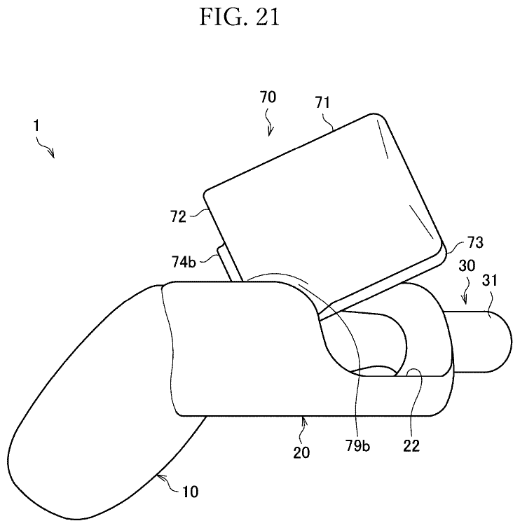

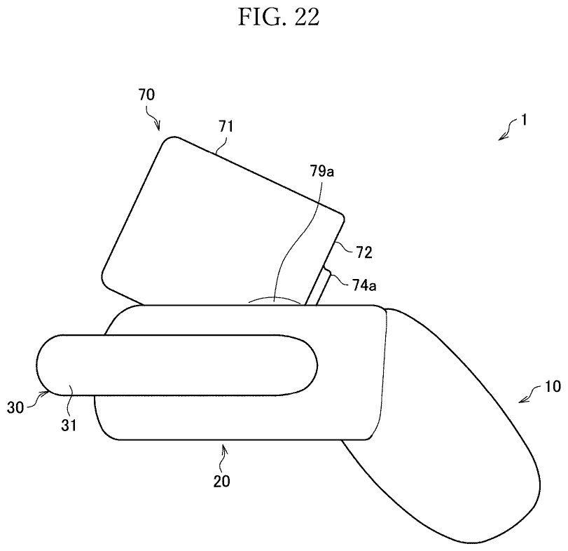

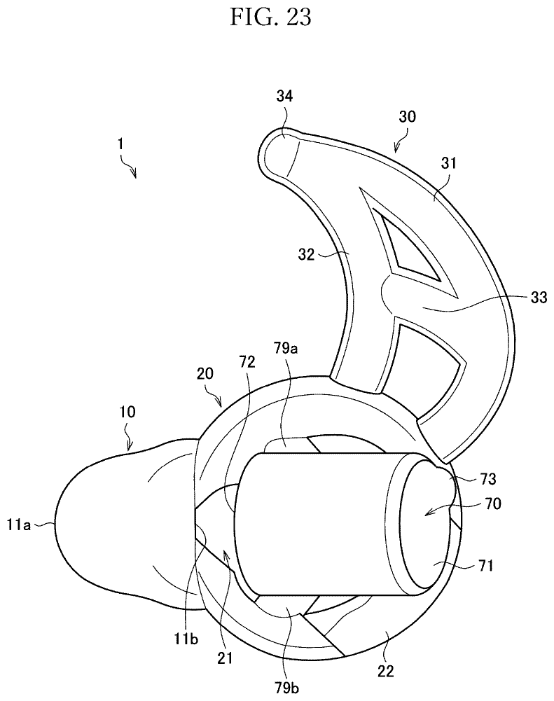

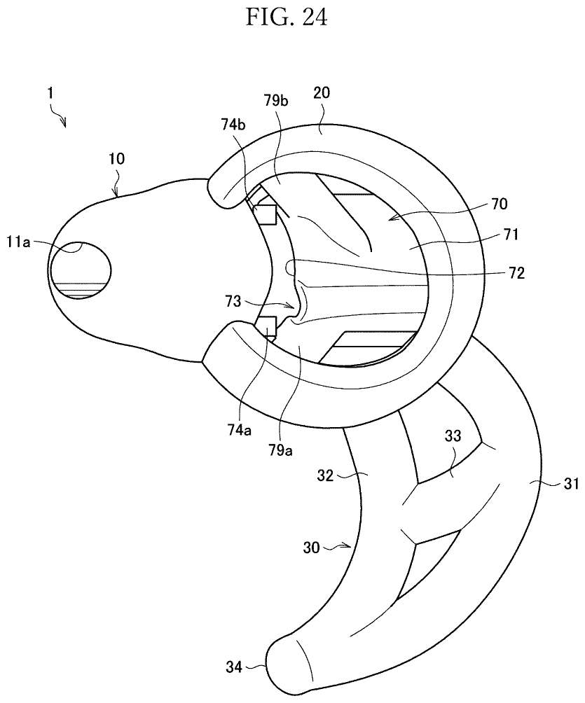

FIG. 17 is a front view of a left ear of a user in which the audio device 1 according to the present embodiment is worn on the left ear. FIG. 18 is a perspective view of the audio device 1 according to the present embodiment. FIG. 19 is a front view of the frame portion of the audio device 1 according to the present embodiment. FIG. 20 is a back view of the frame portion of the audio device 1 according to the present embodiment. FIG. 21 is a right side view of the frame portion of the audio device 1 according to the present embodiment. FIG. 22 is a left side view of the frame portion of the audio device 1 according to the present embodiment. FIG. 23 is a plan view of the frame portion of the audio device 1 according to the present embodiment. FIG. 24 is a bottom view of the frame portion of the audio device 1 according to the present embodiment. It should be noted that the frame portion of the audio device 1 illustrated in FIGS. 19 to 24 refers to a portion other than the sound collection unit 50 and the speaker 110 in the configuration of the audio device 1 illustrated in FIGS. 17 and 18.

As illustrated in FIGS. 17 and 18, the audio device 1 according to the present embodiment includes the insertion unit 10, the first frame 20, the second frame 30, and the sound collection unit 50 as with the audio device 1 according to the first embodiment. Meanwhile, the audio device 1 according to the present embodiment does not include the third frame 40 unlike the audio device 1 according to the first embodiment, but includes a fifth frame 70 and the speaker 110. The audio device 1 is worn on the front surface of the auricle 90 with the second frame 30 abutting the side of the cymba concha 91 closer to the antihelical crus 95, the first frame 20 abutting the cavum concha 92, and the insertion unit 10 inserted to the external auditory canal. The speaker 110 is then disposed on the front surface of the auricle 90, for example, the front surface of the cavum concha 92 when the audio device 1 is worn by a user.

The insertion unit 10, the first frame 20, the second frame 30, and the sound collection unit 50 each have a configuration as described above. The detailed description will be thus omitted.

The speaker 110 also has a configuration as described above. However, in the example illustrated in FIG. 18, the speaker 110 is configured in the shape of a circular column including a surface provided with a sound emission unit 111 and a bottom surface 113 as both ends. The sound emission unit 111 is a section of the speaker 110 that emits sound to the outside of the speaker 110. Specifically, the sound emission unit 111 may be a vibration plate or a hole that communicates with the space in the speaker 110 in which the vibration plate is disposed.

The fifth frame 70 is a member that supports the speaker 110. As illustrated in FIGS. 18 to 24, the fifth frame 70 includes a speaker case 71, a plurality of nail units 74 (74a and 74b), and a plurality of supporting members 79 (79a and 79b).

The speaker case 71 is an example of a storage unit that stores the speaker 110. The speaker case 71 is configured as a bottomed tubular body including an opening 72. In the example illustrated in any of FIGS. 17 to 24, the speaker case 71 is configured in the shape of a cylinder in accordance with the shape of the speaker 110. The speaker case 71 then stores the speaker 110 inserted from the opening 72. In addition, as illustrated in FIGS. 18 to 24, the speaker case 71 is provided with a groove 73. A cable connected to the speaker 110 is disposed in the groove 73 as described below.

As illustrated in FIGS. 18 and 19, each of the nail units 74 is a projection that projects from the outside to the inside of the opening 72 at the end of the speaker case 71 closer to the opening 72. The nail units 74 support the end of the speaker 110 closer to the opening 72 to prevent the speaker 110 stored in the speaker case 71 from falling out. It is possible for a user to insert and pull out the speaker 110 to and from the speaker case 71 by pushing open the nail unit 74a and the nail unit 74b in the opposite directions.

Each of the supporting members 79 is a member that is connected to the first frame 20 and supports the speaker case 71. In other words, each of the supporting members 79 is a member that supports the speaker 110. An end of the supporting member 79 is connected to the first frame 20 and the other end is connected to the speaker case 71. The supporting members 79 support the speaker 110 with the speaker 110 separated from the first frame 20. According to this configuration, it is possible to secure a gap that allows sound coming from the outside world to pass therethrough.

As described above, in the audio device 1 according to the present embodiment, the speaker 110 is supported by the fifth frame 70 and the positions of the sound collection unit 50 and the speaker 110 are thus fixed. As a result, it possible to fix or substantially fix the relative positional relationship between an eardrum of a user, the sound collection unit 50, and the speaker 110. It is thus possible to increase the accuracy of measuring the auricular characteristics when sound for measuring the auricular characteristics is outputted from the speaker 110. As a result, it is thus possible to sufficiently increase a realistic sensation when content subjected to binaural recording by using the sound collection unit 50 is subjected to binaural reproduction from the speaker 110.

In the example illustrated in any of FIGS. 17 to 24, the audio device 1 includes the two supporting members 79 each configured in the shape of a bar. These two supporting members 79 separated from each other are connected to the first frame 20. It is desirable that the two respective supporting members 79 be disposed to be separated from each other as much as possible. As illustrated in FIG. 24, the supporting member 79a and the supporting member 79b may be disposed to be separated at about 90° in a bottom view. According to this configuration, it is possible to eliminate direction dependency with respect to sound that avoids the supporting members 79 and reaches an eardrum of a user.

It should be noted that the configuration of each of the supporting members 79 is not limited to the shape of a bar, but may be a curved shape or the like. In addition, the number of supporting members 79 included in the audio device 1 is not limited to two, but may be three or more. As a larger number of supporting members 79 are included, the supporting members 79 may be narrower. Needless to say, the number of supporting members 79 included in the audio device 1 may be one.

As illustrated in FIG. 18, the speaker 110 is disposed with the sound emission unit 111 of the speaker 110 opposed to the distal end side opening 11b. The distal end side opening 11b is the opening on the side of the through hole 11 provided in the insertion unit 10 opposite to the insertion direction. If described in detail, the speaker case 71 is supported by the supporting members 79 with the opening 72 of the speaker case 71 opposed to the distal end side opening 11b as illustrated in FIGS. 19 and 20. As illustrated in FIG. 18, the speaker 110 is then stored in the speaker case 71 with the sound emission unit 111 exposed from the opening 72. According to this configuration, it is possible to make the shortest the distance between the sound emission unit 111 of the speaker 110 and an eardrum of a user. As a result, it is possible to increase the quality (including the sound volume and the S/N ratio (signal-noise ratio)) of sound that the user catches. In addition, according to this configuration, it is possible to make the shortest the distance between the sound emission unit 111 of the speaker 110 and the sound collection unit 50. As a result, it is thus possible to increase the accuracy of measuring the auricular characteristics when sound for measuring the auricular characteristics is outputted from the speaker 110. Further, the synergistic effects of these make it possible to increase a realistic sensation produced when binaural reproduction is performed by using the speaker 110.

As illustrated in FIG. 17, the speaker 110 is disposed at a position and in an attitude at which and in which the speaker does not interfere with the tragus 99 of the user when the audio device 1 is worn by the user. Specifically, the speaker case 71 that stores the speaker 110 is supported by the supporting members 79 at a position and in an attitude at which and in which the speaker case 71 is separated from the tragus 99 of a user when the audio device 1 is worn by the user. In the example illustrated in FIG. 17, the end of the speaker case 71 that stores the speaker 110 closer to the opening 72 is disposed inside the tragus 99 of a user (i.e., closer to the cavum concha 92) and close to the eardrum. Needless to say, the end of the speaker case 71 that stores the speaker 110 closer to the opening 72 may be disposed outside the tragus 99 of the user and/or farther from the eardrum. In any case, it is possible to increase the wearability of the audio device 1.

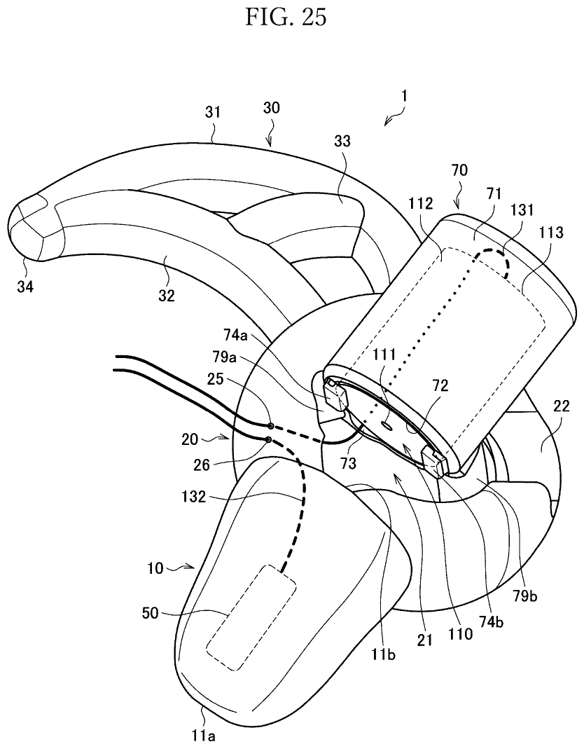

Subsequently, the connection of cables to the sound collection unit 50 and the speaker 110 will be described with reference to FIGS. 25 to 27.

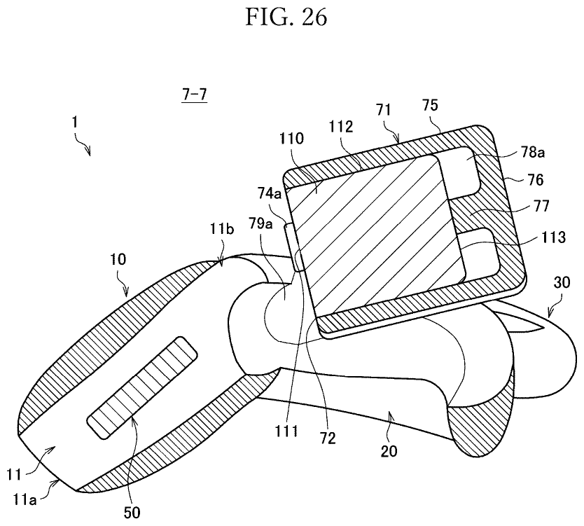

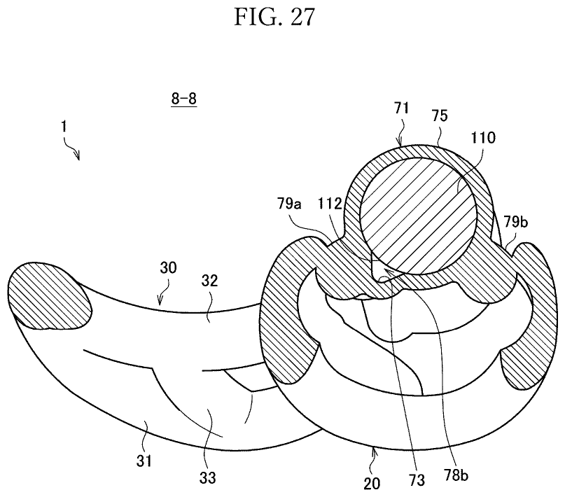

FIG. 25 is a perspective view in which a speaker cable 131 and a mic cable 132 are connected to the audio device 1 according to the present embodiment. FIG. 26 is a cross-sectional view of a cross section of the audio device 1 taken along arrows 7-7 illustrated in FIG. 18. FIG. 27 is a cross-sectional view of a cross section of the audio device 1 taken along arrows 8-8 illustrated in FIG. 18. It should be noted that FIGS. 26 and 27 each omit the speaker cable 131 and the mic cable 132.

As illustrated in FIG. 25, an end of the speaker cable 131 is connected to the speaker 110 and an end of the mic cable 132 is connected to the sound collection unit 50. The speaker cable 131 is a signal path in which an audio signal to be inputted to the speaker 110 is conveyed. The mic cable 132 is a signal path in which an audio signal outputted from the sound collection unit 50 is conveyed. The other ends of the speaker cable 131 and the mic cable 132 are connected to another device such as a PC (Personal Computer) that controls an operation of the audio device 1.

As illustrated in FIG. 25, the speaker 110 is configured in the shape of a circular column including a surface provided with the sound emission unit 111 and the bottom surface 113 as both ends. Meanwhile, the speaker case 71 is configured in the shape of a cylinder to allow the speaker 110 to be stored therein. It is desirable that the outer diameter of the speaker 110 and the inner diameter of the speaker case 71 be the same or substantially the same. In that case, as illustrated in FIGS. 26 and 27, a side surface 112 of the speaker 110 and a side wall 75 of the speaker case 71 come into contact when the speaker 110 is stored in the speaker case 71. As a result, the friction between the side surface 112 of the speaker 110 and the side wall 75 of the speaker case 71 allows the speaker 110 to be locked in the speaker case 71.

As illustrated in FIG. 26, a bottom wall 76 of the speaker case 71 is provided with a projection 77 that projects toward the inside of the speaker case 71. This allows the speaker case 71 to store the speaker 110 with the bottom surface 113 of the speaker 110 separated from the bottom wall 76 of the speaker case 71. According to this configuration, it is possible to secure a space 78a for connecting the speaker cable 131 onto the bottom surface 113 side of the speaker 110.

As illustrated in FIG. 27, the side wall 75 of the speaker case 71 is provided with the groove 73. A gap 78b is formed in the groove 73 between the side wall 75 of the speaker case 71 and the side surface 112 of the speaker 110 when the speaker 110 is stored in the speaker case 71. This gap 78b on the side surface 112 side of the speaker 110 causes the opening 72 and the space 78a on the bottom surface 113 side of the speaker 110 to communicate with each other. As illustrated in FIG. 25, the speaker cable 131 is then connected to the bottom surface 113 of the speaker 110 through the gap 78b on the side surface 112 side of the speaker 110. In other words, in the space 78a on the bottom surface 113 side of the speaker 110, the speaker cable 131 connected to the speaker 110 is pulled out from the side of the speaker 110 closer to the sound emission unit 111, that is, the opening 72 through the gap 78b on the side surface 112 side of the speaker 110. According to this configuration, it is possible to support the speaker cable 131 to sandwich the speaker cable 131 with the speaker case 71 and the speaker 110 and limit the movement of the speaker cable 131. As a result, it is possible to prevent the speaker cable 131 from being cut and prevent the speaker 110 from having a positional shift. Further, it is possible to prevent the movement of the speaker cable 131 from interfering with binaural recording and binaural reproduction.

As illustrated in FIG. 25, the first frame 20 is provided with a first through hole 25. The speaker cable 131 is then disposed through the first through hole 25. According to this configuration, it is possible to support the speaker cable 131 with the first through hole 25 and limit the movement of the speaker cable 131. As a result, it is possible to prevent the speaker cable 131 from being cut and prevent the speaker 110 from having a positional shift. Further, it is possible to prevent the movement of the speaker cable 131 from interfering with binaural recording and binaural reproduction. In addition, as a result of the limited movement of the speaker cable 131, it is possible to suppress the generation of touch noise. The touch noise is noise generated by friction caused by the contact of a cable with a body, clothing, or the like. It should be noted that the first through hole 25 is provided close to the supporting member 79a between the second frame 30 and the insertion unit 10 in FIG. 25, but the first through hole 25 has any position.

As illustrated in FIG. 25, the first frame 20 is provided with a second through hole 26. The mic cable 132 is then disposed through the second through hole 26. According to this configuration, it is possible to support the mic cable 132 with the second through hole 26 and limit the movement of the mic cable 132. As a result, it is possible to prevent the mic cable 132 from being cut and prevent the sound collection unit 50 from having a positional shift. Further, it is possible to prevent the movement of the mic cable 132 from interfering with binaural recording and binaural reproduction. In addition, as a result of the limited movement of the mic cable 132, it is possible to suppress the generation of touch noise. It should be noted that the second through hole 26 is provided close to the supporting member 79a between the second frame 30 and the insertion unit 10 in FIG. 25, but the second through hole 26 has any position.

As illustrated in FIG. 25, it is desirable to provide the first through hole 25 and the second through hole 26 within a close range. Alternatively, one through hole also serving as the first through hole 25 and the second through hole 26 may be provided in the first frame 20. According to this configuration, it is possible to handle the speaker cable 131 and the mic cable 132 more easily.

### <4. Supplemental Information>

Heretofore, preferred embodiments of the present disclosure have been described in detail with reference to the appended drawings, but the present disclosure is not limited thereto. It should be understood by those skilled in the art that various changes and alterations may be made without departing from the spirit and scope of the appended claims.

In any of the first and second embodiments, the example has been described in which the insertion unit 10 includes the through hole 11, but the present disclosure is not limited to this example. For example, the point side opening 11a may be closed. Even in that case, it is possible to perform binaural recording with at least wind noise reduced.

In the first embodiment, the example has been described in which the audio device 1 includes the first frame 20, the second frame 30, and the third frame 40, but the present disclosure is not limited to this example. The audio device 1 does not have to include the second frame 30 or does not have to include the third frame 40. Further, the audio device 1 does not have to include the first frame 20, the second frame 30, and the third frame 40. In the second embodiment, the example has been described in which the audio device 1 includes the second frame 30, but does not include the third frame 40. The present disclosure is not, however, limited to this example. The audio device 1 does not have to include the second frame 30 or includes the third frame 40.

In any of the first and second embodiments, the example has been described in which the audio device 1 includes the insertion unit 10, but the present disclosure is not limited to this example. It is sufficient if the audio device 1 includes the sound collection unit 50 and a member that holds the sound collection unit 50 at the position and the angle described in the first embodiment. The holding mechanism is not limited to the insertion unit 10. For example, the audio device 1 may include an arm-shaped member that supports the sound collection unit 50 from the outside of the external auditory canal 98 instead of the insertion unit 10.

In the first embodiment, the example has been described in which the sound collection unit 50 is disposed at a position on the side of the insertion unit 10 farther from an eardrum of a user when the audio device 1 is worn by the user, but the present disclosure is not limited to this example. For example, in any of the first and second embodiments, the sound collection unit 50 may be disposed at a position on the side of the insertion unit 10 closer to an eardrum of a user when the audio device 1 is worn by the user. Specifically, the sound collection unit 50 may be disposed on the side of the through hole 11 of the insertion unit 10 closer to the point side opening 11a. According to this configuration, it is possible to record sound at a position closer to an eardrum.

### REFERENCE SIGNS LIST

1 audio device
10 insertion unit (10a: inner surface, 10b: outer surface, 10b-1: contact region,
10b-2: noncontact region)
11 through hole (11a: point side opening, 11b: distal end side opening)
20 first frame (20a: inside surface, 20b: outside surface)
21 hollow portion
22 notch
23 fourth frame
24 support
25 first through hole
26 second through hole
30 second frame
31 first columnar body
32 second columnar body
33 third columnar body
34 point
40 third frame
50 sound collection unit
51 vibration section (51a: vibration direction)
52 tone hole
60 filter
70 fifth frame
71 speaker case
72 opening
73 groove
74 (74a, 74b) nail unit
75 side wall
76 bottom wall
77 projection
78a space on bottom surface side of speaker closer
78b gap on side surface side of speaker
79 (79a, 79b) supporting member
90 auricle
91 cymba concha
92 cavum concha
93 helical crus
94 antihelix
95 antihelical crus
96 helix
97 earlobe
98 external auditory canal (98a: inner wall)
100 headphone
110 speaker
120 frame
131 speaker cable
132 mic cable

1. An audio device that is wearable on a user, the audio device comprising
a mic, wherein
the mic is disposed at a position at which at least part of a vibration section of the mic is included inside an external auditory canal of the user and at an angle at which the vibration section has a vibration direction toward an inner wall of the external auditory canal when the audio device is worn by the user.

2. The audio device according to claim 1, wherein the mic is disposed at an angle at which the vibration direction of the vibration section is orthogonal or substantially orthogonal to the inner wall of the external auditory canal when the audio device is worn by the user.

3. The audio device according to claim 1, comprising an insertion unit at least part of which is inserted to the external auditory canal when the audio device is worn by the user, wherein
the mic is disposed in the insertion unit.

4. The audio device according to claim 3, wherein
the insertion unit is configured as a tubular body including a through hole that extends through the tubular body in an insertion direction, and
the mic is disposed inside the through hole with a gap provided between the mic and an inner surface of the insertion unit.

5. The audio device according to claim 3, wherein an outer surface of the insertion unit includes a contact region that comes into contact with the inner wall of the external auditory canal and a noncontact region that is separated from the inner wall of the external auditory canal when the insertion unit is inserted to the external auditory canal.

6. The audio device according to claim 3, wherein the mic is disposed at a position on a side of the insertion unit farther from an eardrum of the user when the audio device is worn by the user.

7. The audio device according to claim 3, comprising a first frame that is disposed in a cavum concha of the user when the audio device is worn by the user, wherein
the first frame is connected to the insertion unit.

8. The audio device according to claim 7, wherein
the first frame is configured in a shape of a ring, and
an outside surface of the first frame abuts the cavum concha when the audio device is worn by the user.

9. The audio device according to claim 8, wherein the first frame is configured to be uneven in thickness.

10. The audio device according to claim 8, comprising a fourth frame configured to close at least part of a hollow portion of the shape of the ring of the first frame.

11. The audio device according to claim 7, wherein
the first frame is configured in a shape of an arc, and
an outside surface of the first frame abuts the cavum concha when the audio device is worn by the user.

12. The audio device according to claim 7, comprising a filter configured to attenuate wind, wherein
the filter is disposed on at least any of the first frame or the insertion unit.

13. The audio device according to claim 7, wherein a speaker is disposed in contact with the first frame.

14. The audio device according to claim 7, comprising a second frame configured to abut a cymba concha of the user when the audio device is worn by the user, wherein
the second frame is connected to the first frame.

15. The audio device according to claim 14, comprising a third frame that is curved to pass through outside of a helical crus of the user from a front surface of an auricle of the user to a back surface of the auricle when the audio device is worn by the user, wherein
the third frame is connected to the first frame.

16. The audio device according to claim 15, wherein a portion of the first frame that is connected to the insertion unit, the second frame, or the third frame is configured to have greater thickness than thickness of another portion.

17. An audio device that is wearable on a user, the audio device comprising:
a mic;
a speaker;
a plurality of supporting members each configured to support the speaker; and
a frame configured to abut an ear of the user when the audio device is worn by the user, wherein
the mic is disposed at a position at which at least part of a vibration section of the mic is included inside an external auditory canal of the user when the audio device is worn by the user, and
a plurality of the supporting members separated from each other is connected to the frame.

18. The audio device according to claim 4, comprising a speaker, wherein
the speaker is disposed with a sound emission unit of the speaker opposed to an opening on an opposite side of the through hole to the insertion direction, the through hole being provided in the insertion unit.

19. The audio device according to claim 1, comprising a speaker, wherein
the speaker is disposed at a position and in an attitude at which and in which the speaker does not interfere with a tragus of the user when the audio device is worn by the user.

20. The audio device according to claim 1, comprising:
a speaker;
a frame configured to abut an ear of the user when the audio device is worn by the user;
a storage unit configured to store the speaker; and
a supporting member that is connected to the frame, the supporting member being configured to support the storage unit, wherein
the storage unit includes an opening and stores the speaker with a sound emission unit of the speaker exposed from the opening, and
a speaker cable that connects the speaker and another device is connected to a bottom surface of the speaker through a through hole and a gap between the speaker and the storage unit, the through hole being provided in the frame, the gap causing the opening and a space on the bottom surface side of the speaker to communicate with each other.
